(19) United States
(12) Patent Application Publication
(10) Pub. No.: US 2012/0237305 A1
(43) Pub. Date: Sep. 20, 2012

(54) Multi-Functional Cutting Tool and Tool Holder Therefor

(75) Inventor: Chul Ho Lee, Dalsung-gun (KR)

(73) Assignee: TAEGUTEC LTD, DALSUNG-GUN DAEGU (KR)

(21) Appl. No.: 13/513,782

(22) PCT Filed: Dec. 23, 2009
(86) PCT No.: PCT/KR09/07725

§ 371 Date: Jun. 4, 2012

(30) Foreign Application Priority Data
Dec. 7, 2009 (KR) 10-2009-0120524

(51) Int. Cl. B23P 15/28; B23B 31/02

(52) U.S. Cl. 407/114; 408/238

(57) ABSTRACT

A multi-functional cutting tool has a first cutting head, a second cutting head positioned opposite to the first cutting head, a shank formed between the first cutting head and the second cutting head, and a chip discharge portion extending from the first cutting head to the second cutting head by way of the shank. The first cutting head has 180 degrees rotational symmetry with the second cutting head about an axis, which passes through the longitudinal center of the cutting tool and is perpendicular to the central axis of the cutting tool. The chip discharge portion comprises a helical portion formed helically with respect to the central axis of the cutting tool such that the chip discharge portion is not positioned on the portion, where a tool holder clamps the cutting tool and a cutting load is concentrated during the cutting process.

### TECHNICAL FIELD

The present invention relates to a multi-functional cutting tool used for various cutting processes (e.g., drilling, boring, turning, etc.) and a tool holder for accommodating the multi-functional cutting tool.

### BACKGROUND ART

FIG. 1 shows a prior art cutting tool, which is mounted to a tool holder. As shown in FIG. 1, a cutting tool (10) comprises a cutting head (12) formed at an end of the cutting tool and a shank (14). The cutting head (12) has a cutting edge (16) for performing a cutting process. The shank (14) is inserted and fixed in a coupling hole of a tool holder (20).

Chips are produced from the cutting edge (16) during the cutting process. The chips should be smoothly discharged in order to prevent the chips from damaging a workpiece or a tool holder. On the other hand, a bending moment is applied to the cutting tool (10) due to the cutting force (F) applied to the cutting edge (16) during the cutting process. When a bending moment is applied, a cutting load is concentrated on a specific portion (30) where the tool holder (20) clamps the cutting tool (10). Thus, the cutting tool (10) must have sufficient strength on the portion where a cutting load is concentrated.

Further, the cutting tool (10) vibrates during the cutting process. Such a vibration increases in proportion to the length from the distal end of the cutting head (12) to the portion where the tool holder (20) begins to clamp the cutting head (12), i.e., overhang length. When the vibration of the cutting tool (10) increases, the tool's life cycle is shortened. Also, the processed surface roughness of a workpiece is degraded. Thus, it is preferable to prevent the vibration of the cutting tool (10) as much as possible during the cutting process.

There has been a strong demand in the art to develop a cutting tool and a tool holder, which can satisfy all of the above-mentioned requirements of the industry.

### DISCLOSURE OF INVENTION

### Technical Problem

The objective of the present invention is to provide a multi-functional cutting tool and a tool holder, which can satisfy all the requirements of the industry. The present invention intends to provide a multi-functional cutting tool with cutting heads at both ends thereof. The multi-functional cutting tool comprises a chip discharge portion, which enables the cutting tool to smoothly discharge the chips generated during the cutting process and have sufficient strength on the portion where a tool holder clamps the cutting tool.

Further, the present invention intends to provide a tool holder receiving a multi-functional cutting tool according to the present invention. When the cutting tool is mounted to the tool holder, the chips produced during the cutting process can be smoothly discharged outside the tool holder. Moreover, the overhang length can be adjusted to be the same as a cutting depth, thereby minimizing the vibration of the cutting tool.

### Technical Solution

In order to achieve the above objective, the present invention provides a multi-functional cutting tool comprising a first cutting head, a second cutting head positioned opposite to the first cutting head, a shank formed between the first cutting head and the second cutting head, and a chip discharge portion extending from the first cutting head to the second cutting head by way of the shank. The first cutting head has 180 degrees rotational symmetry with the second cutting head about an axis, which passes through the longitudinal center of the cutting tool and is perpendicular to the central axis of the cutting tool. The chip discharge portion comprises a helical portion formed helically with respect to the central axis of the cutting tool such that the chip discharge portion is not positioned on the portion, where a tool holder clamps the cutting tool and a cutting load is concentrated during the cutting process.

Preferably, the chip discharge portion comprises a first helical portion formed helically with respect to the central axis of the cutting tool, a second helical portion formed helically with respect to the central axis of the cutting tool, and a straight portion extending parallel to the central axis of the cutting tool between the first helical portion and the second helical portion. The first helical portion extends from the first cutting head towards the second cutting head. The second helical portion extends from the second cutting head towards the first cutting head. Preferably, one or more planes are formed on the circumferential surface of the shank.

A tool holder according to one embodiment of the present invention comprises a housing receiving a multi-functional cutting tool according to the present invention. The housing comprises a tool hole and an opening. The tool hole is formed inwardly from the forward end of the housing and receives the cutting tool. The opening connects a side of the tool hole and an outer surface of the housing. When the cutting tool is inserted into the tool hole, the chip discharge portion of the cutting tool is aligned with the opening.

The housing of the tool holder further comprises a stopper hole. The stopper hole is formed inwardly from the rear end of the housing and is connected to the tool hole. A stopper screw is movably coupled to the stopper hole. The tool holder further comprises a support adapter. The support adapter is positioned over the border between the tool hole and the stopper hole. One end of the support adapter contacts the cutting tool and the other end thereof contacts the stopper screw. The tool holder further comprises one or more screw holes connected to the tool hole through an outer surface of the housing. One or more clamping screws are fastened into the screw holes to fix the cutting tool.

A tool holder according to another embodiment of the present invention comprises a first housing receiving a multi-functional cutting tool according to the present invention, and a second housing receiving the first housing. The first housing comprises a tool hole formed inwardly from the forward end of the first housing in order to receive the cutting tool, and an opening connecting a side of the tool hole and an outer surface of the first housing. When the cutting tool is inserted into the tool hole, the chip discharge portion of the cutting tool is aligned with the opening.

The first housing of the tool holder further comprises a stopper hole. The stopper hole is formed inwardly from the rear end of the first housing and is connected to the tool hole. A stopper screw is movably coupled to the stopper hole. The tool holder further comprises a support adapter. The support adapter is positioned over the border between the tool hole and the stopper hole. One end of the support adapter contacts the cutting tool and the other end thereof contacts the stopper screw. The tool holder further comprises one or more screw holes connecting an outer surface of the first housing and an outer surface of the second housing. One or more clamping screws are fastened into the screw holes to press the portion where the opening of the first housing is formed.

### Advantageous Effects

The present invention provides a multi-functional cutting tool with cutting heads at both ends thereof. The multi-functional cutting tool comprises a chip discharge portion, which enables the cutting tool to smoothly discharge the chips generated during the cutting process and have sufficient strength on the portion where a tool holder clamps the cutting tool. Further, the present invention provides a tool holder receiving a multi-functional cutting tool according to the present invention. When the cutting tool is mounted to the tool holder, the chips produced during the cutting process can be smoothly discharged outside the tool holder. Also, the overhang length can be adjusted to be the same as a cutting depth, thereby minimizing the vibration of the cutting tool.

### BRIEF DESCRIPTION OF DRAWINGS

FIG. 1 is a perspective view of a prior art cutting tool mounted to a tool holder.

FIG. 2 is a perspective view of a cutting tool according to a first embodiment of the present invention.

FIG. 3 is a side view taken in the direction of axis Y of the cutting tool of FIG. 2.

FIG. 4 is an exploded perspective view of a tool holder according to a first embodiment of the present invention.

FIG. 5 is a perspective view of the tool holder of FIG. 4 while receiving the cutting tool according to the present invention.

FIG. 6 is a perspective view omitting only the housing of the tool holder of FIG. 5.

FIG. 7 is a perspective view of a support adapter according to the present invention.

FIG. 8 is a perspective view of a comparative cutting tool mounted to a tool holder.

FIG. 9 is a perspective view of a tool holder according to a second embodiment of the present invention.

FIG. 10 is a perspective view of the first housing of the tool holder of FIG. 9.

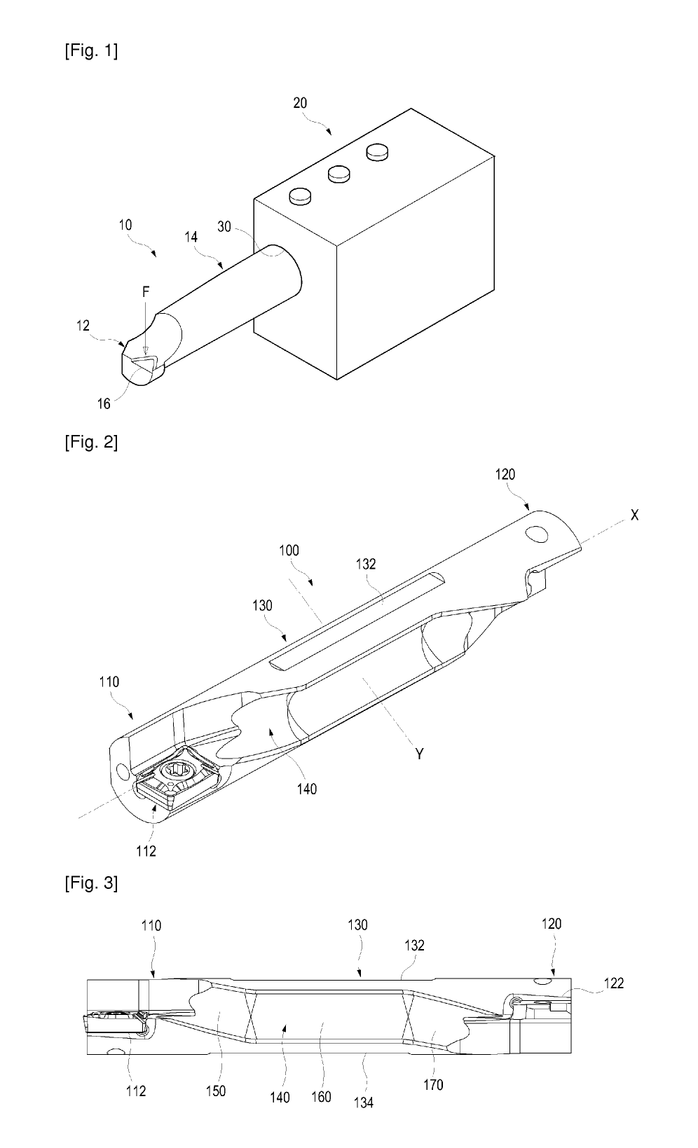

### MODE FOR THE INVENTION

A multi-functional cutting tool according to the present invention and a tool holder to receive and fix such a multi-functional cutting tool are described below in detail with reference to the accompanying drawings.

FIG. 2 is a perspective view of a multi-functional cutting tool according to one embodiment of the present invention. As shown in FIG. 2, the cutting tool (100) is generally cylindrical shape and has a constant diameter in its longitudinal direction. The cutting tool (100) includes cutting heads (110, 120) at its both ends. Cutting insert pockets (112, 122) are formed in the cutting heads (110, 120). A cutting insert is mounted in a cutting insert pocket to provide a cutting edge. Alternatively, a cutting edge can be directly formed on a cutting head without a cutting insert pocket. A shank (130) is formed between the cutting heads (110, 120). Two planes (132, 134) opposite to each other are formed on the circumferential surface of the shank (130). A chip discharge portion (140) continuously extends from the cutting head (110) to the opposing cutting head (120) by way of the shank (130).

Further, the cutting tool (100) has 180 degrees rotational symmetry about an axis (Y), which passes through the longitudinal center of the cutting tool and is perpendicular to the central axis (X) of the cutting tool. After the cutting head (110) on one end of the cutting tool (100) is used for cutting, the cutting head (120) on the other end of the cutting tool (100) can be used for cutting by rotating the cutting tool 180 degrees. Thus, the tool's life cycle can be doubled compared to a prior art cutting tool with only one cutting head.

FIG. 3 is a side view taken in the direction of axis Y of the cutting tool of FIG. 2. As shown in FIG. 3, the chip discharge portion (140) comprises a first helical portion (150), a straight portion (160) and a second helical portion (170). The first helical portion (150) is formed helically with respect to the central axis (X) of the cutting tool (100) and extends from the first cutting head (110) towards the second cutting head (120). The second helical portion (170) is formed helically with respect to the central axis (X) of the cutting tool and extends from the second cutting head (120) towards the first cutting head (110). The straight portion (160) extends parallel to the central axis (X) of the cutting tool (100) and connects the first helical portion (150) and the second helical portion (170). This configuration of the chip discharge portion (140) enables chips produced during the cutting process to be smoothly discharged outward.

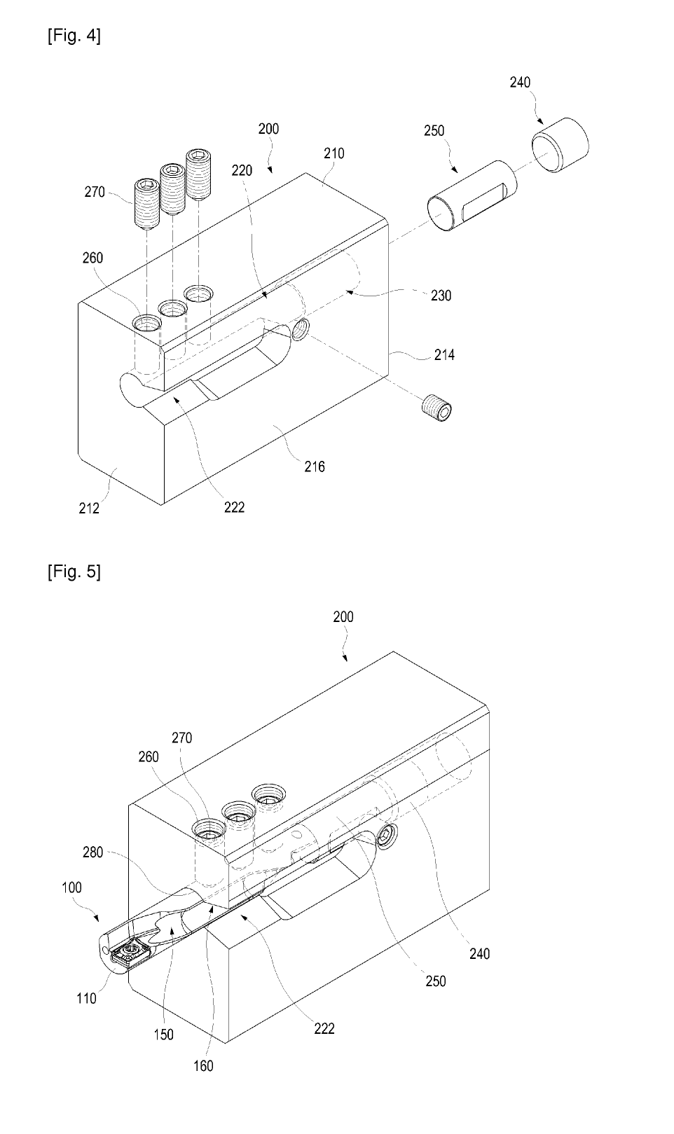

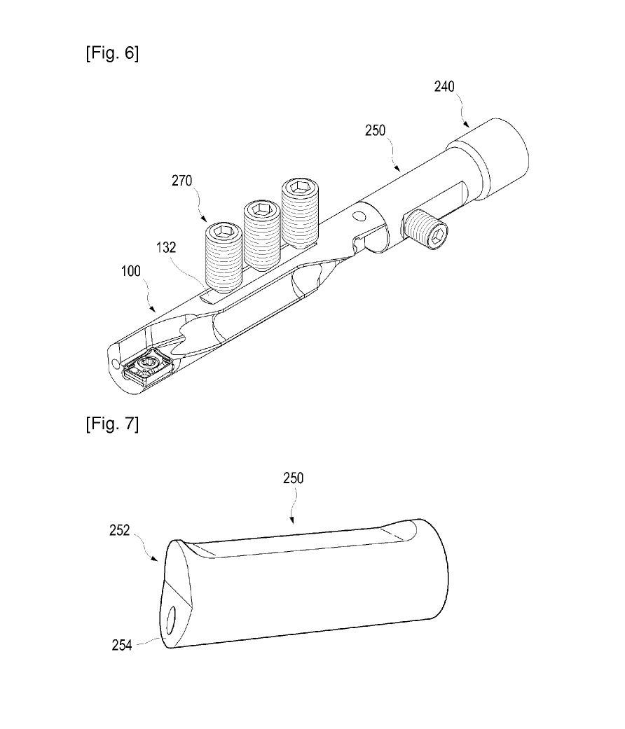

FIG. 4 is an exploded perspective view of a tool holder according to a first embodiment of the present invention. FIG. 5 is a perspective view of the tool holder of FIG. 4 while receiving the cutting tool according to the present invention. FIG. 6 is a perspective view omitting only the housing of the tool holder of FIG. 5.

As shown in FIG. 4, the housing (210) of the tool holder (200) includes a tool hole (220) formed inwardly from the forward end (212) of the housing (210), and a stopper hole (230) formed inwardly from the rear end (214) of the housing (210). The tool hole (220) and the stopper hole (230) are connected to each other. The diameter of the tool hole (220) is smaller than that of the stopper hole (230).

A portion of the cutting tool (100) is inserted and received in the tool hole (220) of the housing (210). A side of the tool hole (220) is open to an outer surface (216) of the housing (210) via an opening (222). As shown in FIG. 5, the chip discharge portion (140) of the cutting tool (100) is aligned with the opening (222) when the cutting tool (100) is inserted into the tool hole (220). When chips are produced from a cutting edge of the cutting head (110) during the cutting process, the chips are introduced into the chip discharge portion (140). The first helical portion (150) guides the chips to the straight portion (160). Then, the chips are discharged outward through the opening (222) of the housing (210). Thus, the chips are not accumulated within a tool holder and do not damage a workpiece or a tool holder.

A stopper screw (240) is inserted and fastened in the stopper hole (230) of the housing (210) by screw engagement. A support adapter (250) is positioned between the cutting head (120) of the cutting tool (100) and the stopper screw (240). The support adapter (250) is positioned over the border between the tool hole (220) and the stopper hole (230). The cutting head (120) of the cutting tool (100) may contact the stopper screw (240) directly without the support adapter (250). However, the use of the support adapter (250) prevents the cutting tool (100) from contacting the stopper screw (240) directly since one end of the support adapter (250) contacts the cutting tool (100) and the other end thereof contacts the stopper screw (240). Thus, the support adapter prevents the damage of a cutting edge or a support surface of the stopper screw, which occurs when the cutting edge of the cutting tool contacts the stopper screw directly.

FIG. 7 is a perspective view of a support adapter. As shown in FIG. 7, a forward surface (252) of a support adapter (250) contacts the cutting head (120) of the cutting tool (100) and includes an inclined surface (254). Only the inclined surface (254), which is a portion of the forward surface (252), contacts a relatively flat portion of the cutting head where a cutting edge is not formed. Thus, the forward surface (252) of the support adapter (250) does not contact a sharp cutting edge. Further, since the inclined surface (254) abuts the cutting head (120), the inclination of the inclined surface (254) prevents rotation of the cutting tool (100), thereby fixing the cutting tool (100) securely.

On the other hand, since the stopper screw (240) is fastened into the stopper hole (230) by screw engagement, it is movable in the longitudinal direction of the tool holder (200). Moving the stopper screw (240) changes the depth of the cutting tool (100) inside the tool hole (220). Thus, the overhang length can be adjusted to be the same as a cutting depth by controlling the position of the stopper screw (240), thereby minimizing the vibration of the cutting tool (100) during the cutting process.

As shown in FIGS. 4 and 5, the housing (210) of the tool holder (200) includes one or more screw holes (260) which are connected to the tool hole (220) through an outer surface of the housing (210). Clamping screws (270) are fastened into the screw holes (260) and press the circumferential surface of the cutting tool (100) to fix the cutting tool (100) in place. As shown in FIG. 6, since the clamping screws (270) contact the plane (132) formed on the circumferential surface of the shank (130), the clamping screws (270) do not slip and fix the cutting tool (100) securely.

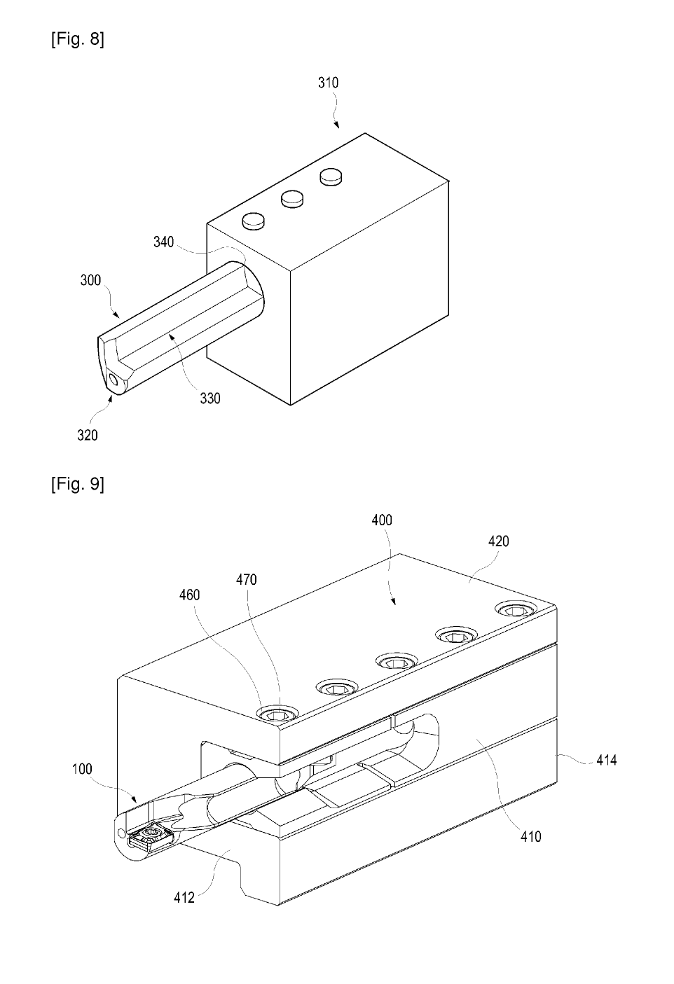

FIG. 8 is a perspective view of a comparative cutting tool mounted to a tool holder. The comparative cutting tool (300) includes a chip discharge portion (330) straightly extending parallel to the central axis of the cutting tool from one cutting head (320) to the other cutting head (not shown). As shown in FIG. 8, the chip discharge portion (330) of the comparative cutting tool (300) is positioned on the specific portion (340), where the tool holder (310) clamps the cutting tool (300) and a cutting load is concentrated due to a bending moment applied during the cutting process. On the contrary, as shown in FIG. 5, according to the present invention, the chip discharge portion (140) of the cutting tool (100) includes a helical portion formed helically with respect to the central axis of the cutting tool (100). Thus, the chip discharge portion (140) is not positioned on the specific portion (280), where the tool holder (200) clamps the cutting tool (100) and a cutting load is concentrated. Accordingly, the cutting tool (100) according to the present invention can have sufficient strength on the portion where a cutting load is concentrated compared to the comparative cutting tool (300).

FIG. 9 is a perspective view of a tool holder according to a second embodiment of the present invention. The tool holder (400) according to the second embodiment has basically the same technical constitution as the tool holder (200) according to the first embodiment. Thus, the detailed explanations on the identical features will be omitted herein, and only the differences between the tool holder (200) and the tool holder (400) will be explained.

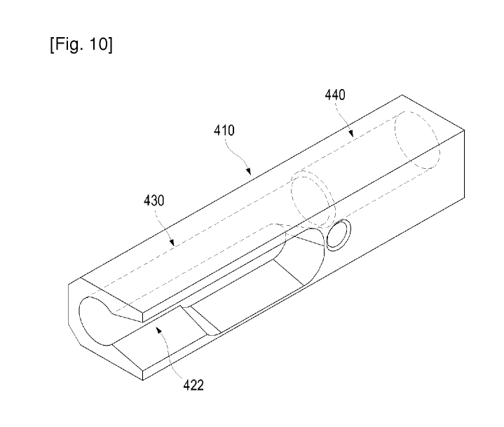

The tool holder (200) comprises one housing (210), whereas the tool holder (400) comprises a first housing (410) and a second housing (420). FIG. 10 is a perspective view of the first housing (410) of the tool holder (400). In the tool holder (200) according to the first embodiment, the clamping screws (270), which are fastened into the screw holes (260), directly contact the cutting tool (100) to fix the cutting tool (100). On the contrary, in the tool holder (400) according to the second embodiment, screw holes (460) connect an outer surface of the first housing (410) and an outer surface of the second housing (420).

The tool holder (400) includes 5 screw holes (460) in the shown embodiment, although it is not limited thereto. 3 clamping screws (470) are fastened into the 3 screw holes (460) sequentially from the forward end (412), thereby pressing the portion where the opening (422) of the first housing (410) is formed. The pressure of the clamping screws (470) deforms the first housing (410) and decreases the inner diameter of the tool hole (430). Accordingly, the cutting tool (100) is fixed in place. 2 clamping screws (470) are fastened into the other 2 screw holes (460) and press the first housing (410), thereby fixing the first housing (410) within the second housing (420). In the tool holder (400), when replacing the cutting tool, only 3 clamping screws (470) sequentially from the forward end (412) need to be loosened. In the tool holder (400), when using another cutting tool with a different diameter, only the first housing (410) for receiving the cutting tool needs to be replaced while the second housing (420) remains unchanged. Thus, there is no inconvenience to replace whole tool holder with another tool holder in order to use a cutting tool with a different diameter.

Although the invention has been described based on its desirable embodiments, it is understood that such detail is solely for the purpose of illustration, and variations can be made therein by those skilled in the art without departing from the spirit and scope of the invention.

1. A multi-functional cutting tool having a central axis (x), comprising:
a first cutting head;
a second cutting head positioned opposite to the first cutting head;
a shank formed between the first cutting head and the second cutting head;
a chip discharge portion extending from the first cutting head to the second cutting head by way of the shank;
wherein the first cutting head has 180 degrees rotational symmetry with the second cutting head about an axis, which passes through a longitudinal center of the cutting tool and is perpendicular to the central axis of the cutting tool; and
wherein the chip discharge portion comprises a helical portion formed helically with respect to the central axis of the cutting tool such that the chip discharge portion is not positioned on the portion, where a tool holder clamps the cutting tool and a cutting load is concentrated during the cutting process.

2. The cutting tool according to claim 1, wherein the chip discharge portion comprises:
a first helical portion formed helically with respect to the central axis of the cutting tool, the first helical portion extending from the first cutting head towards the second cutting head;
a second helical portion formed helically with respect to the central axis of the cutting tool, the second helical portion extending from the second cutting head towards the first cutting head; and
a straight portion extending parallel to the central axis of the cutting tool between the first helical portion and the second helical portion.

3. The cutting tool according to claim 1, wherein one or more planes are formed on a circumferential surface of the shank.

4. A tool holder comprising a housing configured to receive a multi-functional cutting tool according to claim 1,
wherein the housing comprises a tool hole formed inwardly from a forward end of the housing in order to receive the cutting tool, and an opening connecting a side of the tool hole and an outer surface of the housing, and
wherein the chip discharge portion of the cutting tool is aligned with the opening when the cutting tool is inserted into the tool hole.

5. The tool holder according to claim 4, further comprising a stopper screw, wherein the housing further comprises a stopper hole, which is connected to the tool hole and is formed inwardly from a rear end of the housing, and
wherein the stopper screw is movably coupled to the stopper hole.

6. The tool holder according to claim 5, further comprising a support adapter, wherein the support adapter is positioned over a border between the tool hole and the stopper hole, and
wherein one end of the support adapter contacts the cutting tool and the other end thereof contacts the stopper screw, when the cutting tool is inserted the tool holder.

7. The tool holder according to claim 4, further comprising one or more screw holes connected to the tool hole through an outer surface of the housing, and one or more clamping screws fastened into the screw holes to fix the cutting tool, when the cutting tool is inserted into the tool holder.

8. A tool holder, comprising:
a first housing configured to receive a multi-functional cutting tool according to claim 1; and
a second housing receiving the first housing;
wherein the first housing comprises a tool hole formed inwardly from a forward end of the first housing in order to receive the cutting tool, and an opening connecting a side of the tool hole and an outer surface of the first housing; and
wherein the chip discharge portion of the cutting tool is aligned with the opening when the cutting tool is inserted into the tool hole.

9. The tool holder according to claim 8, further comprising a stopper screw,
wherein the first housing further comprises a stopper hole, which is connected to the tool hole and is formed inwardly from the rear end of the first housing, and
wherein the stopper screw is movably coupled to the stopper hole.

10. The tool holder according to claim 9, further comprising a support adapter,
wherein the support adapter is positioned over a border between the tool hole and the stopper hole, and
wherein one end of the support adapter contacts the cutting tool and the other end thereof contacts the stopper screw, when the cutting tool is inserted into the tool hole.

11. The tool holder according to claim 8, further comprising one or more screw holes connecting an outer surface of the first housing and an outer surface of the second housing, and one or more clamping screws fastened into the screw holes to press the portion where the opening of the first housing is formed.

12. A multi-functional cutting tool having a central axis (x), comprising:
a first cutting head;
a second cutting head positioned opposite to the first cutting head;
a shank formed between the first cutting head and the second cutting head and having a clamping portion on a circumferential surface thereof;
a chip discharge portion extending from the first cutting head to the second cutting head by way of the shank;
wherein the first cutting head has 180 degrees rotational symmetry with the second cutting head about an axis, which passes through a longitudinal center of the cutting tool and is perpendicular to the central axis of the cutting tool; and
wherein the chip discharge portion comprises:
a first helical portion formed helically with respect to the central axis of the cutting tool, the first helical portion extending from the first cutting head towards the second cutting head;
a second helical portion formed helically with respect to the central axis of the cutting tool, the second helical portion extending from the second cutting head towards the first cutting head; and
a straight portion extending parallel to the central axis of the cutting tool between the first helical portion and the second helical portion.

13. The cutting tool according to claim 12, wherein the first and second helical portions do not extend beyond the clamping portion of the shank from opposite ends of the cutting tool.

14. The cutting tool according to claim 13, wherein the clamping portion comprises one or more planes formed on the circumferential surface of the shank.

15. A tool holder comprising:
a first housing comprising a tool hole formed inwardly from a forward end of the first housing, and an opening connecting a side of the tool hole and an outer surface of the first housing, the opening extending from the forward end of the first housing part-way along a length of the first housing, and
the cutting tool according to claim 12 received into the tool hole with at least part of the straight portion aligned with the opening of the first housing.

16. The tool holder according to claim 15, further comprising:
a second housing having the first housing received therein.

17. The tool holder according to claim 16, further comprising:
a plurality of screw holes connecting an outer surface of the first housing and an outer surface of the second housing, and
one or more clamping screws fastened into a corresponding number of screw holes to press together the first and second housings where the opening of the first housing is formed.

18. The tool holder according to claim 17, further comprising:
one more clamping screws fastened into a corresponding number of screw holes to press together the first and second housings where the opening of the first housing is not formed.

19. The tool holder according to claim 15, wherein:
the first housing comprises a stopper hole which is connected to the tool hole and is formed inwardly from a rear end of the first housing;
a support adapter is located in the stopper hole; and
a stopper screw is coupled to the stopper hole such that a first end of the support adapter contacts the cutting tool and a second end of the support adapter contacts the stopper screw.
